(19) United States
(12) Patent Application Publication
(10) Pub. No.: US 2005/0089093 A1
(43) Pub. Date: Apr. 28, 2005

(54) NETWORK-BASED SYSTEM AND RELATED METHOD FOR PROCESSING MULTI-FORMAT VIDEO SIGNALS

(76) Inventors: Chuan-Ching Su, Kao-Hsiung Hsien (TW); Cheng-Te Tseng, Hsin-Chu City (TW); Chang-Hung Lee, Yun-Lin Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,048

(22) Filed: Oct. 21, 2004

(30) Foreign Application Priority Data
Oct. 23, 2003 (TW) 092129472

(51) Int. Cl. H04N 7/12

(52) U.S. Cl. 375/240.12; 375/240.01

(57) ABSTRACT

A video signal processing system is used for generating a plurality of kinds of video signals, and each kind of video signal corresponds to a video format. The video signal processing system includes a bus for transmitting data and a plurality of signal processing modules, each of which is used for generating a kind of video signal. The plurality of signal processing modules, which are connected to each other via the bus, include a predetermined signal processing module to be a master processor for controlling operations of the video signal processing system.

### BACKGROUND OF INVENTION

1. Field of the Invention

The invention relates to a video signal processing system and related method for generating a plurality of video signals, and more particularly, to a video signal processing system and related method for utilizing a bus for coupling a plurality of signal processing modules to each other and utilizing a predetermined signal processing module to control operations of the video signal processing system.

2. Description of the Prior Art

MPEG-1, MPEG-2, and MPEG-4 are all ISO/IEC standards developed by the Moving Picture Experts Group (MPEG) proven to be beneficial in digital television, interactive graphics, and interactive multimedia. Unlike its predecessors, MPEG-1 and MPEG-2 that basically standardized a way to sequentially present a series of pictures to the user, MPEG-4 represents a totality of possible multiple media objects, each of which may be real or generated by a computer. The media objects are described and synchronized in such a way that they can be combined to form compound audiovisual scenes easily transmitted over a network.

MPEG-1 is the first standard introduced by the MPEG organization, which is defined by a video resolution of 320×240 at approximately 30 frames per second with a video compression ratio of 1.2 Mbps and an audio compression of approximately 250 kbps. The audio and video data are blended together into a video clip played at approximately 1.5 Mpbs, which is stored in a CD-ROM and played with a CD-Player at double speed. The MPEG-2 standard greatly improved the shortcomings of the MPEG-1 standard not only by improving the picture and sound quality but at the same time providing additional features such as multi-lingual, multi-subtitle, multi-angle, scene division, and the like. In terms of sound quality, MPEG-2 adapts a similar audio compression method as MPEG-1 but added advanced audio coding (AAC). The picture quality of MPEG-2 is boosted up to a resolution of 720×480 by implementing some new video and audio compression techniques to improve picture clarity and to provide more efficient compression ratios. Please refer to FIG. 1, which is a functional block diagram of a prior-art typical MPEG signal processing system 10 that can be mainly used to generate data conforming to the MPEG-1 or MPEG-2 specifications. The MPEG signal processing system 10 includes a processor 12 and an MPEG codec module 14. The processor 12 is electrically coupled to the MPEG codec module 14 for controlling operations of the MPEG codec module 14 and other operations. The MPEG codec module 14 can process data conforming to the MPEG-1 or MPEG-2 specifications via an encoding/decoding procedure to transform a received A/V signal to an audio signal and a video signal conforming to the MPEG-1 or MPEG-2 specifications. Afterwards, the audio signal and the video signal will be respectively transmitted to an audio device, a displayer, a storage device, a VCD/DVD player, or a recorder via the control of the processor 12. In addition, when being implemented with hardware, the processor 12 and the MPEG codec module 14 can be respectively individual integrated chips or be integrated onto a single integrated chip.

The MPEG-1 and MPEG-2 specifications are similar and can be easily simultaneously implemented in a present DVD player/recorder, while the MPEG-2 and MPEG-4 specifications have great difference in compression operation so that the MPEG-2 and MPEG-4 specifications are hard to integrate/implement in a single apparatus. Nowadays, since all the electronic devices are required to be equipped with a data-transmission function, an urgent requirement emerges for integrating various compressing techniques (MPEG-1, MPEG-2, and MPEG-4) into a single apparatus.

### SUMMARY OF INVENTION

It is therefore one of the objectives of the claimed invention to provide a video signal processing system and related method for generating a plurality of video signals to solve the above-mentioned problems.

In the claimed invention, we disclose a video signal processing system that can operate network transmission and generate a plurality of the video signals. The plurality of video signals conforms to various formats including MPEG-1, MPEG-2, and MPEG-4 specifications and other video/audio formats. The video signal processing system of the present invention includes a bus and a plurality of signal processing modules, wherein the bus can be used to couple a plurality of signal processing modules of the video signal processing system to each other and a predetermined signal processing module among the plurality of signal processing modules can be used to control the video signal processing system. Therefore, under various conditions, different compression techniques can be utilized to generate corresponding video signals to meet various requirements.

According to the claimed invention, a video signal processing system for generating a plurality of video signals is disclosed. Each video signal corresponds to a video format, and the video signal processing system comprises a bus for transmitting data and a plurality of signal processing modules, utilized for generating at least a video signal, coupled to each other via the bus.

According to the claimed invention, a method for processing a plurality of video signals in a video signal processing system is disclosed. The video signal processing system comprises a bus and a plurality of signal processing modules. The method comprises: utilizing the bus to be coupled to the plurality of signal processing modules; utilizing a predetermined signal processing module to control operations of the video signal processing system; and utilizing the plurality of signal processing modules to generate the plurality of video signals.

According to the claimed invention, a video signal processing system for processing a plurality of video signals is disclosed. The plurality of video signals respectively correspond to a plurality of video formats, and the plurality of video formats at least comprise a first video format and a second video format. The video signal processing system comprises: a peripheral component interconnect bus (PCI Bus) for transmitting data; a first signal processing module coupled to the bus for generating the video signal of the first video format; a second signal processing module coupled to the bus for generating the video signal of the second video format; a multiplexing device electrically coupled to the first signal processing module and the second signal processing module for receiving an A/V signal and for transmitting the A/V signal to the first signal processing module or the second signal processing module; and a network module electrically coupled to the bus for providing network service.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a prior-art typical MPEG signal processing system.

FIG. 2 is a functional block diagram of an embodiment of a video signal processing system according to the present invention.

FIG. 3 is a flow chart of a method embodiment according to the present invention.

FIG. 4 is a functional block diagram of another embodiment of a video signal processing system according to the present invention.

FIG. 5 is a functional block diagram of a detailed embodiment.

FIG. 6 is a functional block diagram of software architecture according to the present invention.

FIG. 7 is a functional block diagram of a detailed embodiment shown in FIG. 5.

FIG. 8 is a flow chart of a first embodiment according to the present invention.

FIG. 9 is a flow chart of a second embodiment according to the present invention.

FIG. 10 is a flow chart of a third embodiment according to the present invention.

FIG. 11 is a flow chart of a fourth embodiment according to the present invention.

FIG. 12 is a flow chart of a fifth embodiment according to the present invention.

### DETAILED DESCRIPTION

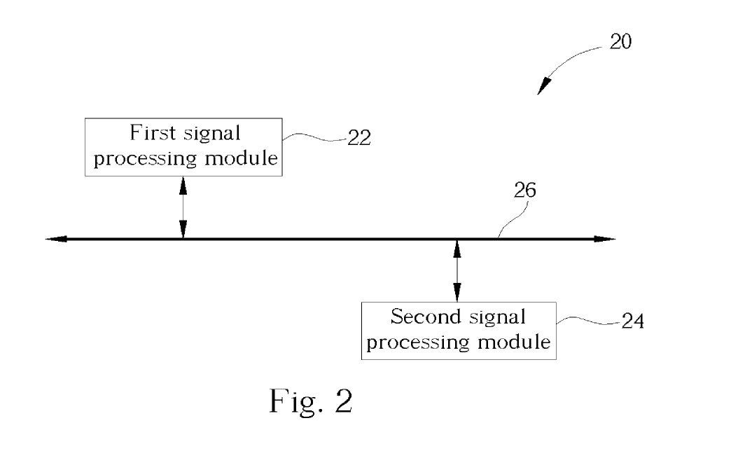

Regarding the structure of the present invention, please refer to FIG. 2, which is a functional block diagram of an embodiment of a video signal processing system 20 according to the present invention. The video signal processing system 20 includes a first signal processing module 22 and a second signal processing module 24. The first signal processing module 22 is used to generate the video signal of a first video format, while the second signal processing module 24 is used to generate the video signal of a second video format. The video signal processing system 20 further includes a bus 26 used to couple the first signal processing module 22 and the second signal processing module 24 to each other; that is, in the video signal processing system 20 of the present invention, the bus 26 is used to build the interconnection between the first and the second signal processing modules 22, 24 so that the video signal can be transmitted between the first and the second signal processing modules 22, 24.

One of the characteristics of the present invention is that the video signal processing system 20 utilizes a predetermined signal processing module to control operations of the whole video signal processing system 20. In the present embodiment, the first signal processing module 22 can be set as a predetermined signal processing module, while the second signal processing module 24 can be controlled by the first signal processing module 22. In other words, the first signal processing module 22 is a master processor, and the second signal processing module 24 is a slave processor. The master processor (the first signal processing module 22) can control the slave processor (the second signal processing module 24). Actually, in the present embodiment, the predetermined signal processing module (the master processor) is not constrained to be the first signal processing module 22 or the second signal processing module 24. The present embodiment utilizes two signal processing modules (the first signal processing module 22 and the second signal processing module 24) to process two video signals (the video signal of the first video format and of the second video format), and determines a signal processing module as the master processor to control the video signal processing system 20, so that the control operation can be unified to avoid the interference among the signal processing modules.

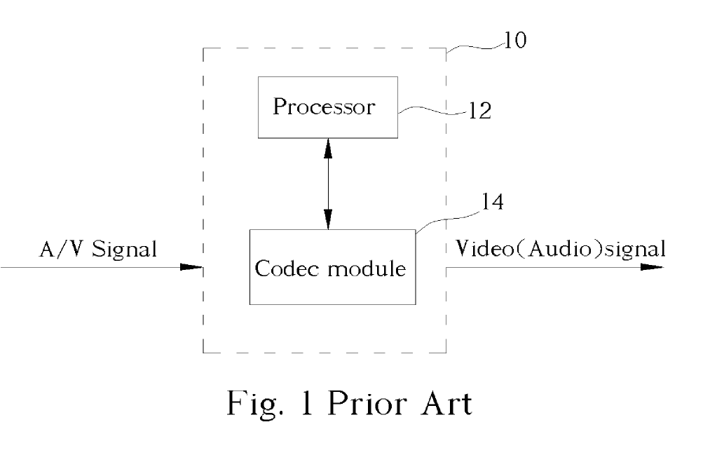

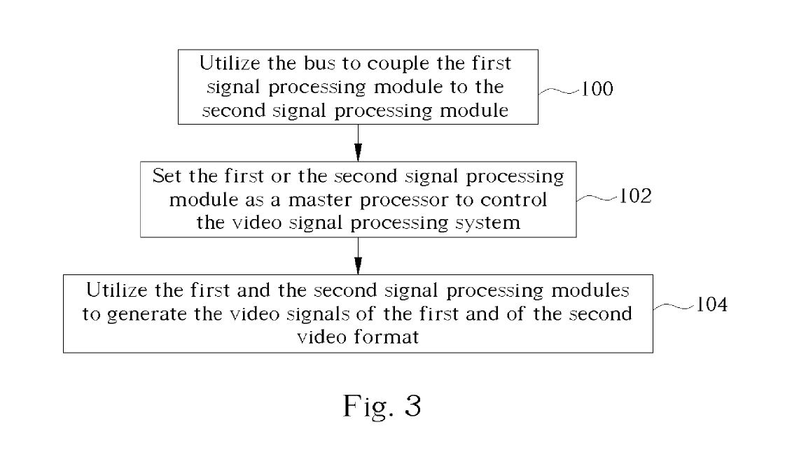

When being implemented, the bus 26 can be a peripheral component interconnect bus 26 (PCI Bus), the first video signal corresponding to the first video format conforms to an MPEG-1 specification or an MPEG-2 specification, while the second video signal corresponding to the second video format conforms to an MPEG-4 specification. Therefore, the first signal processing module 22 can transform a received A/V signal or other signals into the video signal conforming to the MPEG-1 or MPEG-2 specifications. Similarly, the second signal processing module 24 can receive various signals and generate the video signal conforming to the MPEG-4 specification. In addition, the first signal processing module 22 shown in FIG. 2, which can be implemented with a single integrated chip, can be treated as the MPEG signal processing system 10 shown in FIG. 1. According to the above-mentioned of the video signal processing system 20, a method embodiment of the present invention for processing the video signals of two different formats can refer to FIG. 3 with following steps included. FIG. 3 is a flow chart of a method embodiment according to the present invention.
Step 100: utilize the bus 26 to couple the first signal processing module 22 to the second signal processing module 24;
Step 102: set the first signal processing module 22 or the second signal processing module 24 as a predetermined signal processing module; set the predetermined signal processing module as the master processor to control the video signal processing system 20; set the other signal processing module as the slave processor (controlled by the master processor);
step 104: utilize the first signal processing module 22 to generate the video signal of the first video format and utilize the second signal processing module 24 to generate the video signal of the second video format.

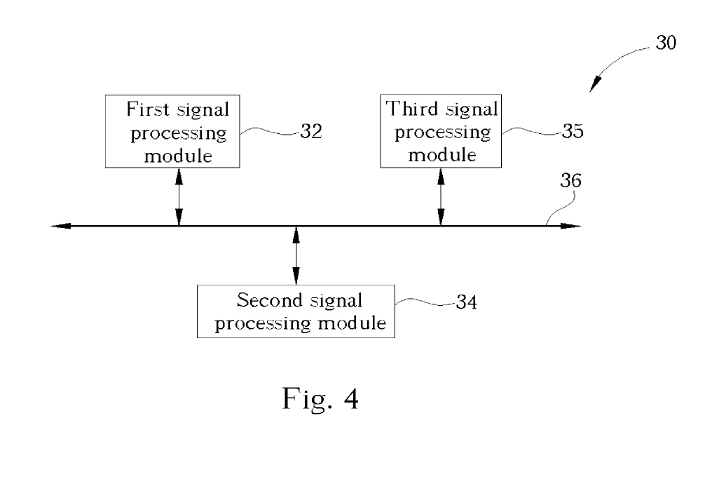

Actually, the video signal processing system 20 does not necessarily need to include just two signal processing modules (the first signal processing module 22 and the second signal processing module 24 shown in FIG. 2); that is, the apparatus and method of the present invention can be used to process the video signals of a plurality of video formats. Therefore, the video signal processing system 20 of the present invention can include a plurality of signal processing modules respectively corresponding to the plurality of video formats, while the bus 26 is utilized to connect the plurality of signal processing modules to each other so that the video signal processing system 20 can generate the video signals of a plurality of video formats. Moreover, a predetermined signal processing module among the plurality of signal processing modules is chosen as the master processor and is used to control the video signal processing system 20, while other signal processing modules among the plurality of signal processing modules are set as slave processors complying with the control of the master processor. Please refer to FIG. 4, which is a functional block diagram of another embodiment of a video signal processing system 30 according to the present invention. The amount of the signal processing modules should not be constrained in the present embodiment. The more signal processing modules that are integrated into the system, the more video formats can be processed. As shown in FIG. 4, the video signal processing system 30 of the present embodiment includes a peripheral component interconnect bus 36, a first signal processing module 32, a second signal processing module 34, and a third signal processing module 35. The first, second, and third signal processing modules 32, 34, 35 are coupled to the peripheral component interconnect bus 36 respectively used to generate the video signals of first, second, and third video formats. Users can determine a predetermined signal processing module from the first, second, and third signal processing modules 32, 34, 35 as the master processor to control the video signal processing system 30.

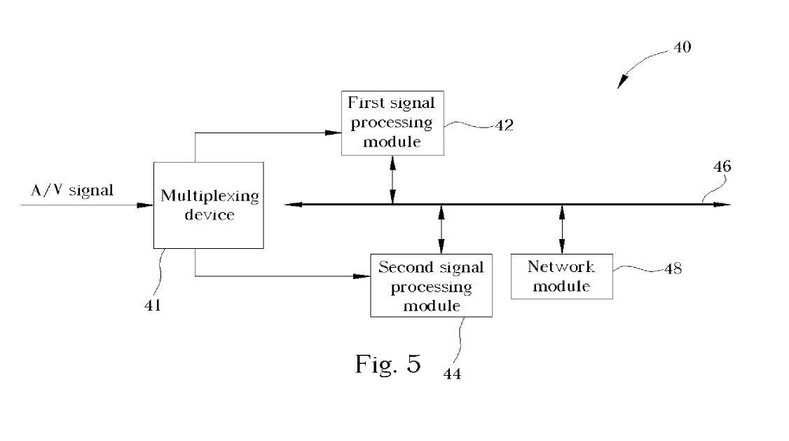

Based off of the structure shown in FIG. 2, a video signal processing system 40 having the function of network transmission is shown in FIG. 5, which is a functional block diagram of a detailed embodiment. The video signal processing system 40 includes a peripheral component interconnect bus 46 (PCI Bus), a multiplexing device 41, a first signal processing module 42, a second signal processing module 44, and a network module 48. The first signal processing module 42 is coupled to the peripheral component interconnect bus 46 and used to generate the video signal of the first video format; the second signal processing module 44 is also coupled to the peripheral component interconnect bus 46 and used to generate the video signal of the second video format. The multiplexing device 41 is electrically coupled to the first signal processing module 42 and the second signal processing module 44 and used to receive an A/V signal and to transmit the A/V signal to the first signal processing module 42 or the second signal processing module 44 for advanced process. The network module 48 is electrically coupled to the peripheral component interconnect bus 46 and used to receive a video signal from a network environment, such as a WLAN. In addition, the network module 48 can communicate with the first signal processing module 42 and the second signal processing module 44 via the peripheral component interconnect bus 46 to output the video signal generated by those two signal processing modules to the network environment in order to provide network services. When being implemented, if the first video format conforms to the MPEG-1 or MPEG-2 specifications and the second video format conforms to the MPEG-4 specification, the network module 48 can be mainly used to receive and output the video signal conforming to the MPEG-4 specification.

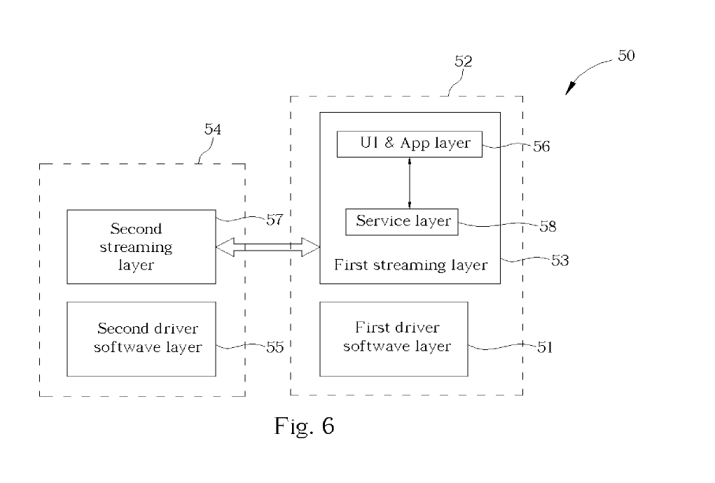

Users can set the first signal processing module 42 as the master processor to control operations of the second signal processing module 44 and the network module 48. Please notice that when the second signal processing module 44 is controlled by the first signal processing module 42, the multiplexing device 41 can be electrically coupled to only the first signal processing module 42 (the multiplexing device 41 is not electrically coupled to the second signal processing module). When users want to set the video format as the first video format, the first signal processing module 42 will transmit the A/V signal to the first signal processing module 42 for transforming the A/V signal into the video signal of the first video format; when users want to set the video format as the second video format, the first signal processing module 42 can transmit the A/V signal to the second signal processing module 44 for transforming the A/V signal into the video signal of the second video format. Since the corresponding software architectures of the first signal processing module 42 and the second signal processing module 44 are different, an interface has to be included between the software architectures of the first signal processing module 42 and the second signal processing module 44 so that the first signal processing module 42 can smoothly control the second signal processing module 44. Please refer to FIG. 6, which is a functional block diagram of a software architecture 50 according to the present invention. The software architecture 50 includes two software structures of two signal processing modules shown in FIG. 5. A first software structure 52 and a second software structure 54 respectively correspond to the first signal processing module 42 and the second signal processing module 44 shown in FIG. 5. The first software structure 52 includes a first driver software layer 51 and a first streaming layer 53. The first streaming layer 53 includes a service layer 58 and a UI & App layer 56. The second software structure 54 includes a second driver software layer 55 and a second streaming layer 57. Please notice that in the first software structure 52, the service layer 58 can be treated not only as an operating interface of the second software structure 54 but also as the interface between the first and the second software structures 52, 54. Therefore, by the operations of the service layer 58, the first and the second software structures 52, 54 can communicate with each other at the streaming layer (the first streaming layer 53 and the second streaming layer 57) so that the first signal processing module 42 can control the second signal processing module. The design of the software architecture aims at the characteristic of the hardware structure of the present invention. In addition, due to the service layer 58, users can control the service layer 58 so as to operate the second software structure 54 after slightly modifying the UI & App layer of the first software structure 52 without needing to adjust the content of the first driver software layer 51 and the second driver software layer 55.

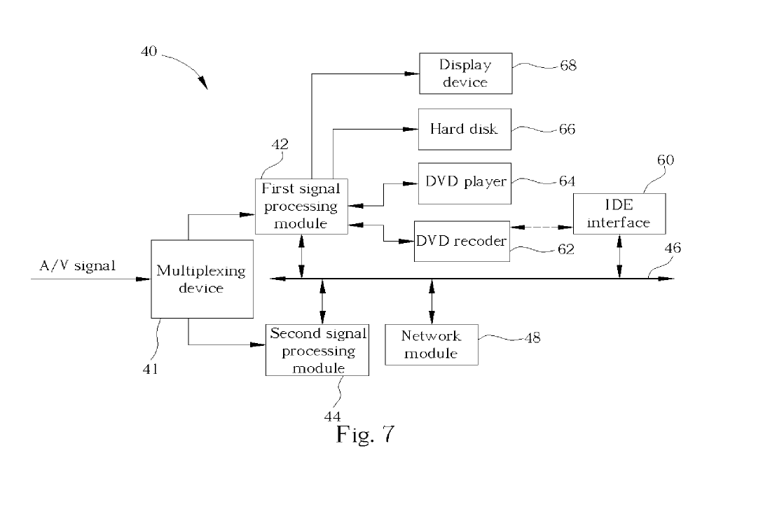

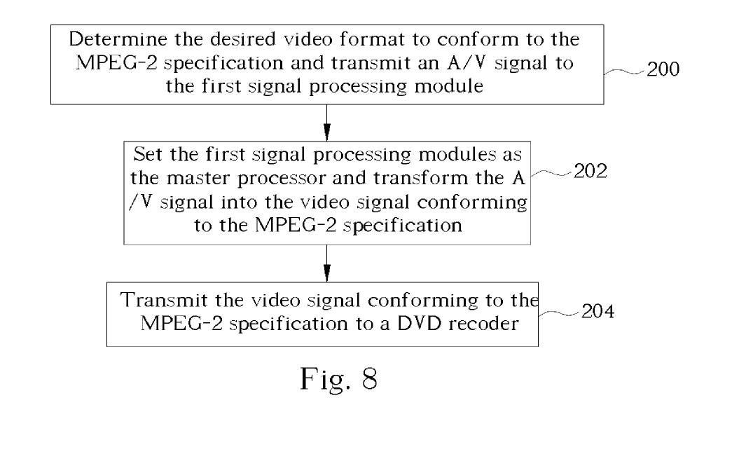

Please refer back to FIG. 5. The structure shown in FIG. 5 can be electrically connected to various audio devices, displayers, storage devices, VCD/DVD players, or recorders. Please refer to FIG. 7, which is a functional block diagram of a detailed embodiment shown in FIG. 5. The video signal processing system 40 shown in FIG. 7 is equal to the structure shown in FIG. 5 added with an integrated device electronics (IDE) interface 60, a DVD recorder 62, a DVD player 64, a hard disk 66, and a display device 68. The VCD/DVD player 64, the hard disk 66, and the display device 68 are electrically coupled to the first signal processing module 42, and the DVD recorder 62 can directly be coupled to the first signal processing module 42 or coupled to the second signal processing module 44 via the IDE interface 60. Based off of the structure shown in FIG. 7, a first method embodiment of the present invention can refer to the following steps shown in FIG. 8:
Step 200: users determine the desired video format (from an OSD image) to conform to the MPEG-2 specification, and the multiplexing device 41 will transmit an A/V signal to the first signal processing module 42 for processing;
Step 202: set the first signal processing module 42 as the master processor, and transform the A/V signal into the video signal conforming to the MPEG-2 specification;
Step 204: utilize the first signal processing module 42 to transmit the video signal conforming to the MPEG-2 specification to the hard disk 66 for being stored, or transmit the video signal conforming to the MPEG-2 specification to a DVD recorder 62 so as to record the video signal onto a DVD disk.

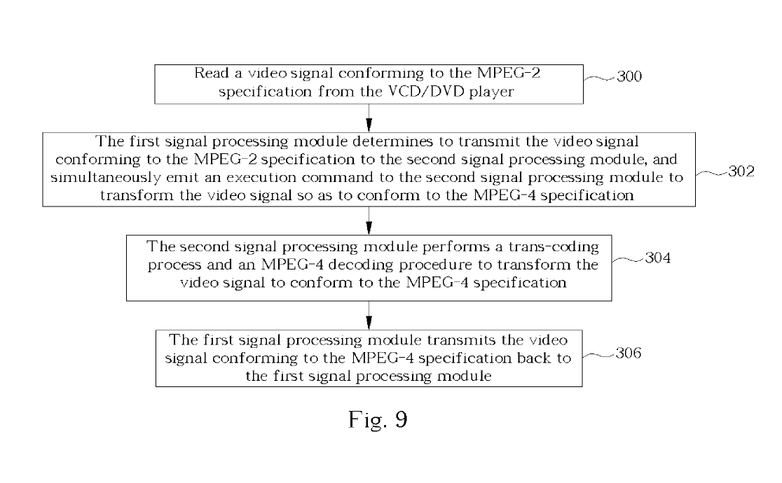

The first embodiment shown in FIG. 8 mainly describes the procedure in which an A/V signal from analog source, such as a TV, CVBS, or S-Video, is transformed into the video signal conforming to the MPEG-2 specification via the first signal processing module 42 and is then stored with digital format. In the embodiment shown in FIG. 8, the second signal processing module 44 is not utilized, and the first signal processing module 42 does not communicate with the second signal processing module 44 so that the service layer 58 of the first software structure 52 shown in FIG. 6 is not utilized. The following embodiment shown in FIG. 9 will utilize the peripheral component interconnect bus 46 and set the first signal processing module 42 as the master processor to control the video signal processing system 40. Please refer to FIG. 9, which shows the procedure that the video signal read from a DVD player 64 is played with the format conforming to the MPEG-4 specification.
Step 300: utilize the first signal processing module 42 to read a video signal conforming to the MPEG-2 specification from the VCD/DVD player 64;
step 302: the first signal processing module 42, the master processor, will determine to transmit the video signal that conforms to the MPEG-2 specification to the second signal processing module 44, and simultaneously emit an execution command to the second signal processing module 44 to make the second signal processing module 44 transform the video signal conforming to the MPEG-2 specification into the video signal conforming to the MPEG-4 specification;
Step 304: the second signal processing module 44 receives the execution command and the video signal conforming to the MPEG-2 specification to perform a trans-coding process so as to transform the video signal conforming to the MPEG-2 specification into the video signal conforming to the MPEG-4 specification. Afterwards, perform an MPEG-4 decoding procedure so that the display device 68 can play the decoded video signal;
Step 306: After the second signal processing module 44 generates the video signal conforming to the MPEG-4 specification, the first signal processing module 42 transmits the video signal conforming to the MPEG-4 specification back to the first signal processing module 42. Afterwards, the display device 68 will play the (decoded) video signal conforming to the MPEG-4 specification.

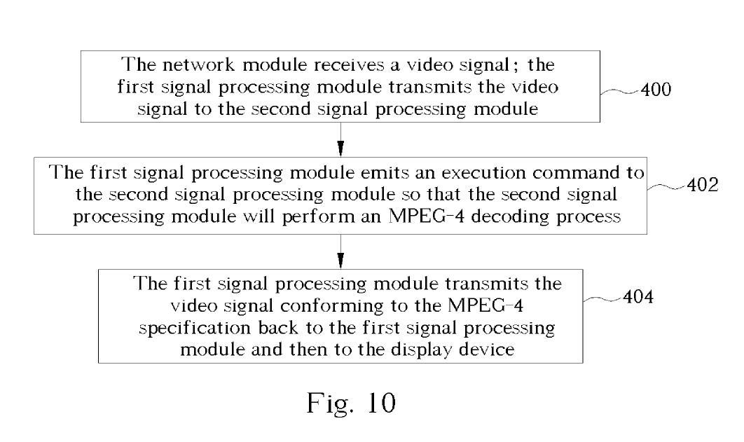

Similar to the embodiment shown in FIG. 9, FIG. 10 shows the procedure that the video signal received by the network module 48 is then played with the format conforming to the MPEG-4 specification.
Step 400: the network module 48 receives a video signal conforming to the MPEG-4 specification; utilize the first signal processing module 42 to transmit the video signal conforming to the MPEG-4 specification to the second signal processing module 44. Please notice that the video signal received by the network module 48 may conform to any specification;
Step 402: the first signal processing module 42 emits an execution command to the second signal processing module 44 so that the second signal processing module 44 will perform an MPEG-4 decoding process. If the original video signal does not conform to the MPEG-4 specification, the second signal processing module 44 will transform the video signal of any other video format into the video signal conforming to the MPEG-4 specification and perform the MPEG-4 decoding process;
step 404: After the second signal processing module 44 generates the video signal conforming to the MPEG-4 specification, the first signal processing module 42 will transmit the video signal conforming to the MPEG-4 specification back to the first signal processing module 42 and then to the display device 68 for playing.

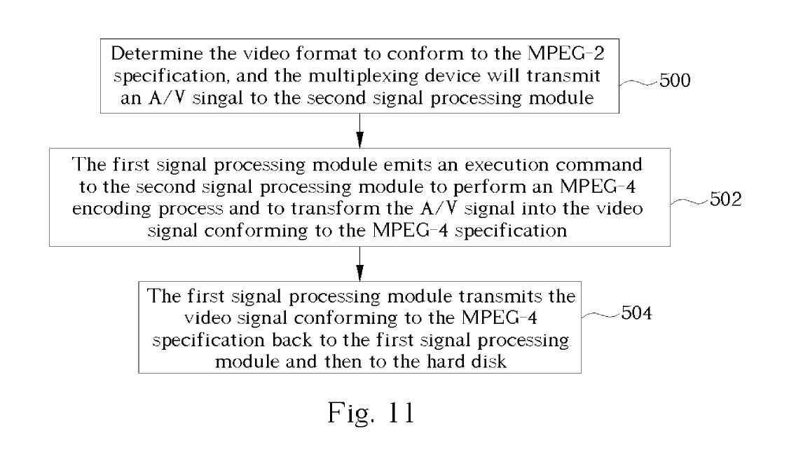

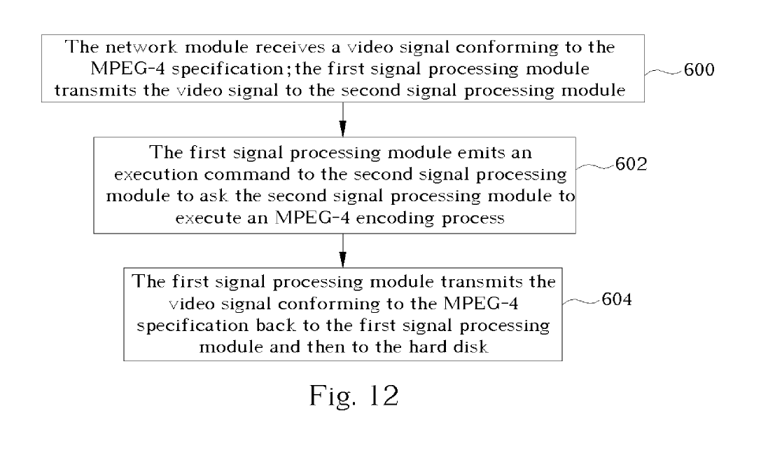

A fourth method embodiment and a fifth method embodiment are disclosed in the following paragraphs. The fourth embodiment shown in FIG. 11 mainly describes a procedure that an A/V signal is transformed into the video signal conforming to the MPEG-4 specification via the second signal processing module 44 and then stored with digital formats. The fifth embodiment shown in FIG. 12 mainly describes a video signal received by the network module 48 and then stored with the format conforming to the MPEG-4 specification. In the fourth and fifth embodiments, the first signal processing module 42 is required to emit an execution command to the second signal processing module 44 to ask the second signal processing module 44 to execute an MPEG-4 encoding procedure to store the (encoded) video signal conforming to the MPEG-4 specification. FIG. 11 includes following steps:
Step 500: users determine the desired video format from an OSD image to conform to the MPEG-2 specification, and the multiplexing device 41 will transmit an A/V signal to the second signal processing module 44 for processing;
Step 502: the first signal processing module 42, the master processor, emits an execution command to the second signal processing module 44 to ask the second signal processing module 44 to transform the A/V signal into the video signal conforming to the MPEG-4 specification. The first signal processing module 42 also asks the second signal processing module 44 to perform an MPEG-4 encoding process to generate the (encoded) video signal conforming to the MPEG-4 specification;
step 504: after the second signal processing module 44 generates the video signal conforming to the MPEG-4 specification, the first signal processing module 42 will transmit the video signal conforming to the MPEG-4 specification back to the first signal processing module 42 and then to the hard disk 66. The first signal processing module 42 can also transmit the video signal conforming to the MPEG-4 specification to the DVD recorder 62 for recording the video signal onto a DVD. Certainly, the first signal processing module 42 can transmit the video signal conforming to the MPEG-4 specification to any digital recorder 62 via the IDE interface 60 coupled to the peripheral component interconnect bus 46.

FIG. 12 includes following steps:
Step 600: the network module 48 receives a video signal conforming to the MPEG-4 specification; utilize the first signal processing module 42 to transmit the video signal conforming to the MPEG-4 specification to the second signal processing module 44. Please notice that the video signal received by the network module 48 may conform to any specification;
step 602: the first signal processing module 42 emits an execution command to the second signal processing module 44 to ask the second signal processing module 44 to execute an MPEG-4 encoding process. If the original video signal does not conform to the MPEG-4 specification, the second signal processing module 44 will transform the video signal of any other video format into the video signal conforming to the MPEG-4 specification and perform the MPEG-4 decoding process;
step 604: after the second signal processing module 44 generates the video signal conforming to the MPEG-4 specification, the first signal processing module 42 will transmit the video signal conforming to the MPEG-4 specification back to the first signal processing module 42 and then to the hard disk 66. The first signal processing module 42 can also transmit the video signal conforming to the MPEG-4 specification to the DVD recorder 62 for recording the video signal onto a DVD. Certainly, the first signal processing module 42 can transmit the video signal conforming to the MPEG-4 specification to any digital recorder 62 via the IDE interface 60 coupled to the peripheral component interconnect bus 46.

In the present invention, we disclose a video signal processing system with the function of network transmission. The video signal processing system can be used to process and generate a plurality of video signals, which conform to MPEG-1, MPEG-2, or MPEG-4 specification, or other video formats. Therefore, under various conditions, different compression techniques can be utilized to generate corresponding video signals to meet various requirements.

Those skilled in the art will readily observe that numerous modifications and alterations of the device and method may be made while retaining the teachings of the invention. Accordingly, the above disclosure should be construed as limited only by the metes and bounds of the appended claims.

1. A video signal processing system for generating a plurality of video signals, each video signal corresponding to a video format, the video signal processing system comprising:
a bus for transmitting data; and
a plurality of signal processing modules, utilized for generating at least a video signal, coupled to each other via the bus.

2. The video signal processing system of claim 1 further comprising a network module electrically coupled to the bus for receiving and outputting at least one video signal.

3. The video signal processing system of claim 1 wherein the plurality of video signals at least comprise a first video signal and a second video signal respectively corresponding to a first video format and a second video format; the plurality of signal processing modules at least comprising a first signal processing module and a second signal processing module for respectively generating the first video signal and the second video signal.

4. The video signal processing system of claim 3 wherein the first video format corresponding to the first video signal conforms to an MPEG-1 specification or an MPEG-2 specification, and the second video format corresponding to the second video signal conforms to an MPEG-4 specification.

5. The video signal processing system of claim 3 wherein the first signal processing module is used to control operations of the video signal processing system.

6. The video signal processing system of claim 3 wherein the second signal processing module is used to control operations of the video signal processing system.

7. The video signal processing system of claim 1 further comprising a multiplexing device electrically coupled to the plurality of signal processing modules for receiving an A/V signal and for transmitting the A/V signal to at least a signal processing module.

8. The video signal processing system of claim 1 wherein the bus is a peripheral component interconnect bus (PCI Bus).

9. A method for processing a plurality of video signals in a video signal processing system, the video signal processing system comprising a bus and a plurality of signal processing modules, the method comprising:
utilizing the bus to be coupled to the plurality of signal processing modules;
utilizing a predetermined signal processing module to control operations of the video signal processing system; and
utilizing the plurality of signal processing modules to generate the plurality of video signals.

10. The method of claim 9 wherein the video signal processing system further comprises a network module electrically coupled to the bus, the method further comprising:
utilizing the network module to receive and output at least a video signal.

11. The method of claim 10 wherein the predetermined signal processing module is a master processor, and other signal processing module(s) among the plurality of signal processing modules is (are) slave processor(s); the master processor is capable of being used to control operations of the slave processor(s) and the network module.

12. The method of claim 11 wherein the video signal generated by the predetermined signal processing module conforms to an MPEG-1 specification or an MPEG-2 specification.

13. The method of claim 12 wherein the video signal processing system is electrically connected to a VCD/DVD player or a recorder for playing or recording the video signal conforming to the MPEG-1 specification or the MPEG-2 specification.

14. The method of claim 9 wherein the video signal processing system further comprises a multiplexing device at least electrically coupled to the predetermined signal processing module, the method further comprising:
utilizing the multiplexing device to receive an A/V signal and to transmit the A/V signal to the predetermined signal processing module.

15. The method of claim 9 wherein the bus is a peripheral component interconnect bus (PCI Bus).

16. A video signal processing system for processing a plurality of video signals, the plurality of video signals respectively corresponding to a plurality of video formats, the plurality of video formats at least comprising a first video format and a second video format, the video signal processing system comprising:
a peripheral component interconnect bus (PCI Bus) for transmitting data;
a first signal processing module coupled to the bus for generating the video signal of the first video format;
a second signal processing module coupled to the bus for generating the video signal of the second video format;
a multiplexing device electrically coupled to the first signal processing module and the second signal processing module for receiving an A/V signal and for transmitting the A/V signal to the first signal processing module or the second signal processing module; and
a network module electrically coupled to the bus for providing network service.

17. The video signal processing system of claim 16 wherein the first video format conforms to an MPEG-1 specification or an MPEG-2 specification, and the second video format conforms to an MPEG-4 specification.

18. The video signal processing system of claim 17 being electrically connected to a VCD/DVD player or a recorder for playing or recording the video signal of the first video format.

19. The video signal processing system of claim 17 wherein the network module is capable of being used to receive and output the video signal of the second video format.

20. The video signal processing system of claim 16 wherein the first signal processing module is capable of being used to control operations of the video signal processing system.
